(19) United States
(12) Patent Application Publication
(10) Pub. No.: US 2020/0142710 A1
(43) Pub. Date: May 7, 2020

(54) SERVER SYSTEM

(71) Applicants: INVENTEC (PUDONG) TECHNOLOGY CORPORATION, Shanghai City (CN); INVENTEC CORPORATION, Taipei City (TW)

(72) Inventors: Ying-Xian HAN, Shanghai City (CN); Ming Liang YU, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/214,763

(22) Filed: Dec. 10, 2018

(30) Foreign Application Priority Data
Nov. 6, 2018 (CN) 201811314464.4

(51) Int. Cl. G06F 9/4401; G06F 9/445; G06F 13/42; H04L 29/08

(52) U.S. Cl. CPC G06F 9/4416; H04L 67/34; G06F 13/4282; G06F 9/44505

(57) ABSTRACT

The present disclosure provides a server system that comprises: a CPLD comprising a first firmware and a first serial peripheral interface; and a serial peripheral read-only memory comprising a second firmware and a second serial peripheral interface; wherein the first serial peripheral interface electrically connects to the second serial peripheral interface through a serial peripheral signal. The CPLD detects the first firmware and the second firmware when the server system is booting. The CPLD sets the first firmware as a main firmware and the first firmware is used for a booting of the server system when the first firmware is detected. The CPLD sets the second firmware as the main firmware when the first firmware is not detected and the second firmware is detected. Through the technical solution of the present disclosure, the server can ensure the normal operation of the system even the CPLD firmware has a problem.

### CROSS-REFERENCE TO RELATED APPLICATIONS

This non-provisional application claims priority under 35 U.S.C. § 119(a) on Patent Application No(s). 201811314464.4 filed in China on Nov. 6, 2018, the entire contents of which are hereby incorporated by reference.

### BACKGROUND

### 1. Technical Field

The present disclosure relates to a technical field of the server, and more particularly to a server system.

### 2. Related Art

Now, the server's motherboard has a PAL (Programmable Array Logic) chip to implement the timing control of the server system's power-on and shutdown as well as some register settings. Therefore, the PAL chip is very important for a server.

During the operating time of the system, if the timing of the firmware or the value of the register is wrong or confusing, the whole system will be shut down. At this time, the traditional approach can only re-update the firmware of the CPLD (complex programmable logic device). However, once the server is in mass production, it is more troublesome for the customer to update the firmware, because they can't easily and familiarly update the firmware and they can only do the return to the factory, which will undoubtedly increase the cost of the company.

### SUMMARY

To achieve the above and other related purposes, the present disclosure provides a server system comprising a CPLD comprising a first firmware and a first serial peripheral interface; and a serial peripheral interface read-only memory comprising a second firmware and a second serial peripheral interface; wherein the first serial peripheral interface electrically connects to the second serial peripheral interface through a serial peripheral signal; wherein the CPLD detects the first firmware and the second firmware when the server system is booting, the CPLD sets the first firmware as a main firmware and the first firmware is used for a booting of the server system when the first firmware is detected, when the first firmware is not detected and the second firmware is detected, the CPLD sets the second firmware as the main firmware and the second firmware is used for the booting of the server system.

In one embodiment of the present disclosure, the CPLD further comprises a control module, a configuration module, a logical module, and a serial peripheral interface control module.

In one embodiment of the present disclosure, the CPLD further comprises a selector electrically connecting to the serial peripheral interface control module, the first serial peripheral interface, and the logical module respectively, the logical module controls the selector to perform a system booting determination to determine whether the first firmware set by the CPLD is used for the booting of the server system or the second firmware set by the serial peripheral interface read-only memory is used for the booting of the server system.

In one embodiment of the present disclosure, the CPLD uses a self-download mode to detect the first firmware.

In one embodiment of the present disclosure, the self-download mode fails when the first firmware is not detected, the CPLD detects the second firmware by a main serial peripheral interface configuration mode.

In one embodiment of the present disclosure, the CPLD uses the configuration module to control the serial peripheral interface control module to be in a master mode, and to control the serial peripheral interface read-only memory to be in a slave mode.

In one embodiment of the present disclosure, the CPLD uses the configuration module to control the serial peripheral interface control module to be in a slave mode, and to control the serial peripheral interface read-only memory to be in a master mode.

In one embodiment of the present disclosure, the first firmware is burned offline by a production line, the second firmware is burned offline by the production line.

In one embodiment of the present disclosure, the first firmware is of joint engineering design standard or Versa Module Europa standard.

In one embodiment of the present disclosure, the second firmware is of binary format.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 shows a schematic of a JTAG switch multiplexing circuit of the CPLD of the present server system;

FIG. 2 shows a structural schematic of the system according to an embodiment of the present disclosure;

FIG. 3 shows a detail structural schematic of the server system in an embodiment of FIG. 2; and

FIG. 4 shows a structural schematic of the server system according to another embodiment of the present disclosure.

### DETAILED DESCRIPTION

The implementation manners of the present disclosure are described below through specific embodiment, and those skilled in the art can readily understand other advantages and effects of the present disclosure from the specification. The present disclosure may also be implemented or applied in different specific implementations. The details of the present disclosure can also be modified or changed based on different points and applications without departing from the spirit of the present disclosure. It should be noted that, in the case without confliction, the following embodiments and features in the embodiment can be combined with each other.

It should be noted that the figures provided in the following embodiments only illustrate the basic concept of the present disclosure in a schematic manner, and only the components related to the present disclosure are shown in the figures, instead of the number, the shape and the size of components in actual implementation. The type, quantity, and proportion of each component in actual implementation can be a kind of random change, and the layout type of the components may be more complicated.

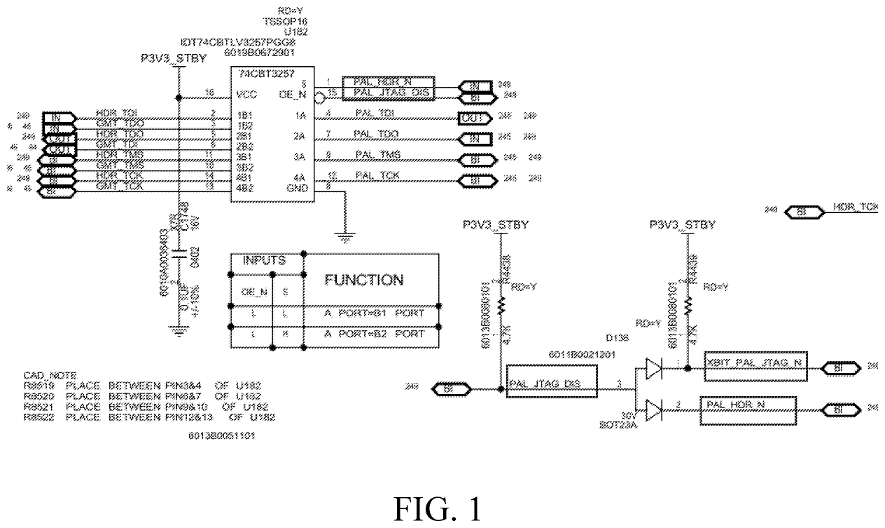

FIG. 1 shows a schematic of a joint test action group (JTAG) switch multiplexing circuit of the complex programmable logic device (CPLD) of the present server system. In the stage of research and development, the server system comprises a joint test action group connector (JTAG CONN), which is electrically connected to a joint test action group interface (JTAG Port) of the CPLD. When the external programming cable is connected to the JTAG Port, the CPLD receives the burning file sent by the external device through the JTAG CONN, and updates the firmware in the CPLD according to the burning file.

As shown in FIG. 1, for example, when both the output enable pin OE_N and the select pin S output a low level, u182 selects JTAG to update the firmware, and XBIT_PAL_JTAG_N is low; that is, PAL_JTAG_DIS is low. As long as the cable is connected to the JTAG CONN, PAL_HDR_N is low. Thus, the switch multiplexing circuit (Switch MUX) selects the JTAG CONN mode, so that JTAG CONN is used to update the firmware of the CPLD. If the cable is not connected to JTAG CONN, PAL_HDR_N is high, XBIT_PAL_JTAG_N is still low; that is, PAL_JTAG_DIS is still low. At this time, u182 will select a GMT mode, that is, the CPLD firmware can be updated in the ILO (Integrated Lights-Out, integrated remote management port on the HP server) mode.

Although the autonomous switching of the CPLD firmware in the flash memory in the JTAG interface mode and the GMT mode can perform well through the switching circuit shown in FIG. 1, that is, the switching between a common JED (Joint engineering Design) format of CPLD firmware and a VME (Versa Module Europa) format may meet the requirements of different experimental groups and different users. However, once entering a mass production of servers, all JTAG CONN will be removed in order to save costs. Once the server fails to boot, the customer can only choose to return to the factory for maintenance, which greatly increases the company's operating costs.

The purpose of the present disclosure is to provide a server system that ensures normal startup of the system when there is a problem with the firmware of the CPLD.

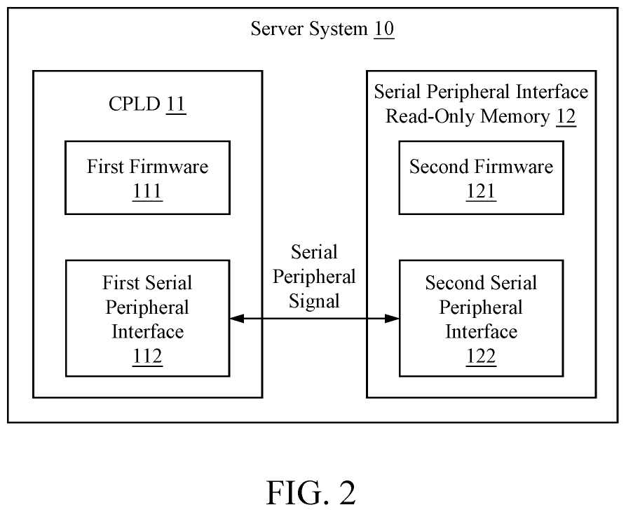

As shown in FIG. 2, the server system 10 of the embodiment comprises a CPLD 11 and a serial peripheral interface read-only memory 12, wherein the CPLD 11 communicatively connects to the serial peripheral interface read-only memory 12.

Specifically, the CPLD 11 comprises a first firmware 111 and a first serial peripheral interface 112. The first firmware 111 is burned beforehand in the CPLD 11 by the production line in an off-line manner, and the format is of, for example, a JED standard or a VME standard. The serial peripheral interface read-only memory 12 comprises a second firmware 121 and a second serial peripheral interface 122. The second firmware 121 is burned beforehand in the serial peripheral interface read-only memory 12 by the production line in an off-line manner, and the format is of, for example, a binary format or the like. The first serial peripheral interface 112 and the second serial peripheral interface 122 are electrically connected through a serial peripheral signal.

The CPLD 11 detects the first firmware 111 and the second firmware 121 when the server system 10 is booting. The CPLD 11 sets the first firmware 111 as a main firmware and the first firmware 111 is used for a booting of the server system when the first firmware 111 is detected; when the first firmware 111 is not detected and the second firmware 121 is detected, the CPLD 11 sets the second firmware 121 as the main firmware and the second firmware 121 is used for the booting of the server system.

In this embodiment, the CPLD 11 uses a self-download mode to detect the first firmware 111. At this time, the CPLD is the master configuration, the serial peripheral interface read-only memory 12 is the slave configuration, the CPLD 11 uses the configuration module 114 to control the serial peripheral interface control module 116 to be in a master mode, and to further control the serial peripheral interface read-only memory 12 to be in a slave mode. The self-download mode fails when the first firmware 111 is not detected. At this time, the serial peripheral interface read-only memory 12 changes to be the master configuration, and the CPLD 11 changes to be the slave configuration. The CPLD 11 uses the configuration module 114 to control the serial peripheral interface control module 116 to be in a slave mode and to further control the serial peripheral interface read-only memory 12 to be in a master mode. The CPLD 11 detects the second firmware 121 by a main serial peripheral interface configuration mode.

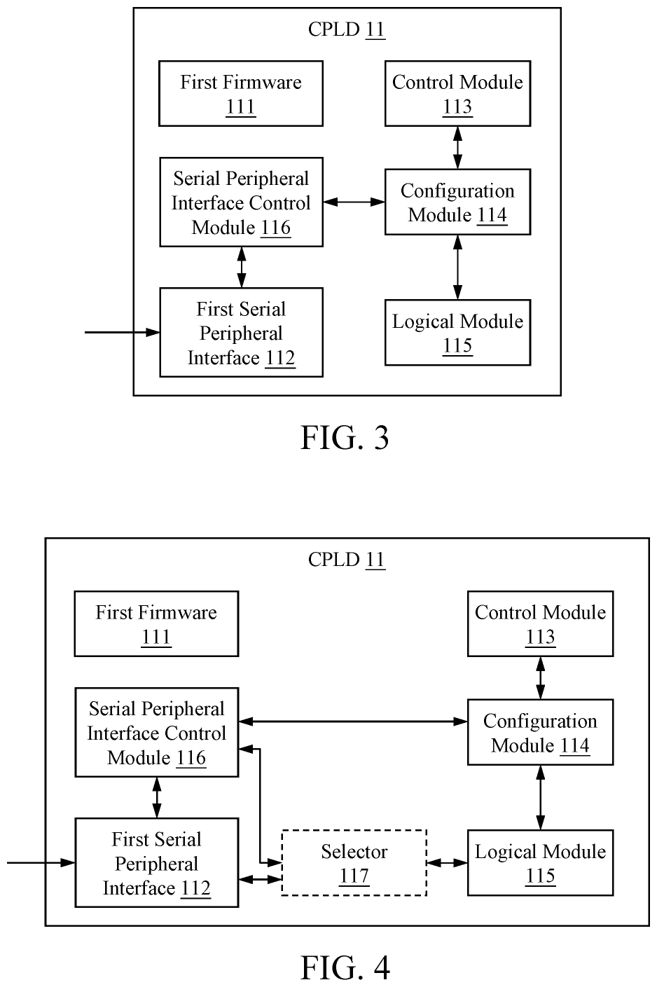

As shown in FIG. 3, the CPLD 11 in this embodiment further comprises a control module 113, a configuration module 114, a logical module 115 and a serial peripheral interface control module 116, wherein the configuration module 114 electrically connect to the control module 113, the logical module 115 and the serial peripheral interface control module 116, respectively.

As shown in FIG. 4, in another embodiment, the CPLD 11 further comprises a selector 117. The selector 117 is electrically connected between the logical module 115 and the serial peripheral interface control module 116, and is connected to the first serial peripheral interface 112 to communicate with the serial peripheral interface read-only memory 12. The logical module 114 controls the selector 117 to perform a system booting determination to determine whether the first firmware 111 set by the CPLD 11 is used for the booting or the second firmware 121 set by the serial peripheral interface read-only memory 12 is used for the booting.

In the stage of research and development of the server system, the joint test action group connector and the serial peripheral interface read-only memory are reserved, that is, the firmware of the CPLD can be updated through the joint test action group connector or through the serial peripheral interface read-only memory. In the final stage of research and development, when the firmware is burned through the JTAG cable for the first time, the CPLD is configured as in a serial peripheral interface non-volatile storage medium programming mode, and the joint test action group connector receives the burning file sent by the external device and updates the second firmware according to the burning file, so the burning task of the serial peripheral interface read-only memory can be completed. Therefore, the firmware inside can be read and converted into a binary file, and the firmware of the serial peripheral interface read-only memory can be updated offline later.

After entering a mass production of the server system, the joint test action group connector is removed, only the serial peripheral interface read-only memory is left, which greatly saves company costs. At this time, there is no need to use the joint test action group connector to update the CPLD, but the firmware of the CPLD and the binary file of the serial peripheral interface read-only memory are updated offline by the production line. In this way, when a customer gets the server system, even if there is a problem such as timing disorder, the main CPLD firmware can be recovered to ensure the normal operation of the system.

In view of the above description, the server system of the present disclosure can ensure the normal operation of the system even in a condition that the CPLD firmware has a problem. Therefore, the present disclosure effectively overcomes various shortcomings in the prior art and has high industrial utilization value.

The embodiments described above are only illustrative of the principles and effects of the disclosure and are not intended to limit the disclosure. Modifications or variations of the embodiments described above may be performed by those skilled in the art without departing from the spirit and scope of the disclosure. Therefore, all equivalent modifications or variations performed by those skilled in the art without departing from the spirit and scope of the disclosure will be covered by the claims of the present disclosure.

What is claimed is:

1. A server system, comprising:
a CPLD comprising a first firmware and a first serial peripheral interface; and
a serial peripheral interface read-only memory comprising a second firmware and a second serial peripheral interface;
wherein the first serial peripheral interface electrically connects to the second serial peripheral interface through a serial peripheral signal;
wherein the CPLD detects the first firmware and the second firmware when the server system is booting, the CPLD sets the first firmware as a main firmware and the first firmware is used for a booting of the server system when the first firmware is detected, when the first firmware is not detected and the second firmware is detected, the CPLD sets the second firmware as the main firmware and the second firmware is used for the booting of the server system.

2. The server system according to claim 1, wherein the CPLD further comprises a control module, a configuration module, a logical module, and a serial peripheral interface control module.

3. The server system according to claim 2, wherein the CPLD further comprises a selector electrically connecting to the serial peripheral interface control module, the first serial peripheral interface, and the logical module respectively, the logical module controls the selector to perform a system booting determination to determine whether the first firmware set by the CPLD is used for the booting of the server system or the second firmware set by the serial peripheral interface read-only memory is used for the booting of the server system.

4. The server system according to claim 2, wherein the CPLD uses a self-download mode to detect the first firmware.

5. The server system according to claim 4, wherein the self-download mode fails when the first firmware is not detected, the CPLD detects the second firmware by a main serial peripheral interface configuration mode.

6. The server system according to claim 4, wherein the CPLD uses a configuration module to control the serial peripheral interface control module to be in a master mode, and to control the serial peripheral interface read-only memory to be in a slave mode.

7. The server system according to claim 5, wherein the CPLD uses a configuration module to control the serial peripheral interface control module to be in a slave mode, and to control the serial peripheral interface read-only memory to be in a master mode.

8. The server system according to claim 1, wherein the first firmware is burned offline by a production line, the second firmware is burned offline by the production line.

9. The server system according to claim 1, wherein the first firmware is of joint engineering design standard or Versa Module Europa standard.

10. The server system according to claim 1, wherein the second firmware is of binary format.
